(19) United States
(12) Patent Application Publication
(10) Pub. No.: US 2026/0138299 A1
(43) Pub. Date: May 21, 2026

(54) PROCESSING APPARATUS AND PROCESSING METHOD

(71) Applicant: TOYOTA JIDOSHA KABUSHIKI KAISHA, Toyota-shi (JP)

(72) Inventors: Naoki KANESHIGE, Komaki-shi (JP); Motoki NAITO, Miyoshi-shi (JP)

(73) Assignee: TOYOTA JIDOSHA KABUSHIKI KAISHA, Toyota-shi (JP)

(21) Appl. No.: 19/367,084

(22) Filed: Oct. 23, 2025

(30) Foreign Application Priority Data
Nov. 20, 2024 (JP) 2024-202090

(51) Int. Cl. B26D 7/02; B21F 11/00; B65H 51/18

(52) U.S. Cl. CPC B26D 7/02; B21F 11/00; B65H 51/18

(57) ABSTRACT

A processing apparatus according to the present disclosure includes a cutting mechanism configured to cut a workpiece transported along a first direction, a first chuck mechanism configured to fix the workpiece such that the workpiece is held stationary while the cutting mechanism is cutting the workpiece, and a second chuck mechanism configured to grip and transport the cut workpiece to a subsequent process, in which a position where the first chuck mechanism fixes the workpiece is provided downstream in the first direction with respect to a position where the cutting mechanism cuts the workpiece, and a position where the second chuck mechanism grips the workpiece is provided downstream in the first direction with respect to the position where the first chuck mechanism fixes the workpiece.

### CROSS-REFERENCE TO RELATED APPLICATION

This application claims priority to Japanese Patent Application No. 2024-202090 filed on Nov. 20, 2024. The disclosure of the above-identified application, including the specification, drawings, and claims, is incorporated by reference herein in its entirety.

### BACKGROUND

### 1. Technical Field

The present disclosure relates to a processing apparatus and a processing method.

### 2. Description of Related Art

A processing apparatus cutting a workpiece that has been transported in a length that is predetermined includes a chuck mechanism transporting the cut workpiece to a subsequent process. Japanese Unexamined Patent Application Publication No. 04-300039 (JP 04-300039 A) discloses a processing apparatus including a cutting blade that cuts a workpiece and a chuck mechanism that is provided in front of the cutting blade in a direction in which the workpiece is transported and transports the cut workpiece to a subsequent process.

### SUMMARY

The inventors have found the following problems with the processing apparatus disclosed in JP 04-300039 A. After the chuck mechanism grips the workpiece transported to the processing apparatus, the cutting blade cuts the workpiece. After the chuck mechanism transports the cut workpiece to the subsequent process, the chuck mechanism returns to the vicinity of the cutting blade. After the chuck mechanism that has returned grips the workpiece to be cut subsequently, the cutting blade cuts the workpiece. Therefore, the cutting blade cannot cut the subsequent workpiece until the cut workpiece is transported to the subsequent process and the chuck mechanism returns to the vicinity of the cutting blade. Accordingly, a problem occurs in that the cycle time increases and the productivity decreases.

The present disclosure is made to solve such a problem, and provides a processing apparatus and a processing method capable of shortening a cycle time.

A processing apparatus according to the present disclosure includes
a cutting mechanism configured to cut a workpiece transported along a first direction,
a first chuck mechanism configured to fix the workpiece such that the workpiece is held stationary while the cutting mechanism is cutting the workpiece, and
a second chuck mechanism configured to grip and transport the cut workpiece to a subsequent process,
in which a position where the first chuck mechanism fixes the workpiece is provided downstream in the first direction with respect to a position where the cutting mechanism cuts the workpiece, and
in which a position where the second chuck mechanism grips the cut workpiece is provided downstream in the first direction with respect to the position where the first chuck mechanism fixes the workpiece.

As described above, the first chuck mechanism that is different from the second chuck mechanism executing the transport of the workpiece fixes the workpiece. Therefore, a subsequent cutting operation can be started without waiting for the second chuck mechanism that transports the workpiece to return. Therefore, the cycle time can be shortened.

In the processing apparatus,
the first chuck mechanism may include a fixed chuck provided at a position that is in contact with the workpiece along the first direction, and a movable chuck provided at a position where the movable chuck clamps the workpiece with the fixed chuck; and
the movable chuck may be cam-driven to move toward and away from the fixed chuck.

In the processing apparatus,
a clamping force of the workpiece by the first chuck mechanism may be based on an elastic force of a spring provided in the movable chuck.

In the processing apparatus,
the workpiece may be a linear member extending along the first direction, and
the cutting mechanism may be provided at a position where the workpiece is clamped between the fixed chuck and the cutting mechanism, and may cut the workpiece on the fixed chuck.

A processing method according to the present disclosure includes
a cutting step of cutting a workpiece fixed by a chuck, and
a transporting step of transporting the cut workpiece to a subsequent process by a chuck different from the chuck,
in which a process of executing the transporting step after the cutting step is executed over a plurality of cycles, and
in which the cutting step in an (n+1)-th process is executed during the execution of the transporting step in an n-th process, n being an integer of 1 or more.

According to the present disclosure, a processing apparatus and a processing method capable of shortening a cycle time and improving productivity can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view showing an example of a processing apparatus according to Embodiment 1;

FIG. 2 is a cross-sectional view showing still another example of the processing apparatus according to the Embodiment 1;

FIG. 3 is a side view of the first chuck mechanism according to the Embodiment 1;

FIG. 4 is a schematic view of a flowchart of one step in the processing method according to the Embodiment 1; and

FIG. 5 is a detailed view of the flowchart of one step in the processing method according to the Embodiment 1.

### DETAILED DESCRIPTION OF EMBODIMENTS

Hereinafter, specific embodiments of the present disclosure will be described in detail with reference to the drawings. However, the present disclosure is not limited to the following embodiments. Further, in order to clarify the explanation, the following description and drawings are appropriately simplified.

### Embodiment 1

### Configuration of Processing Apparatus

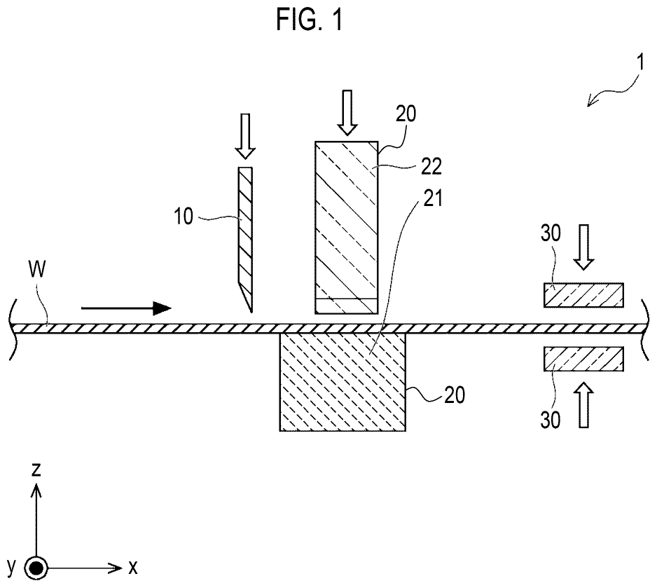

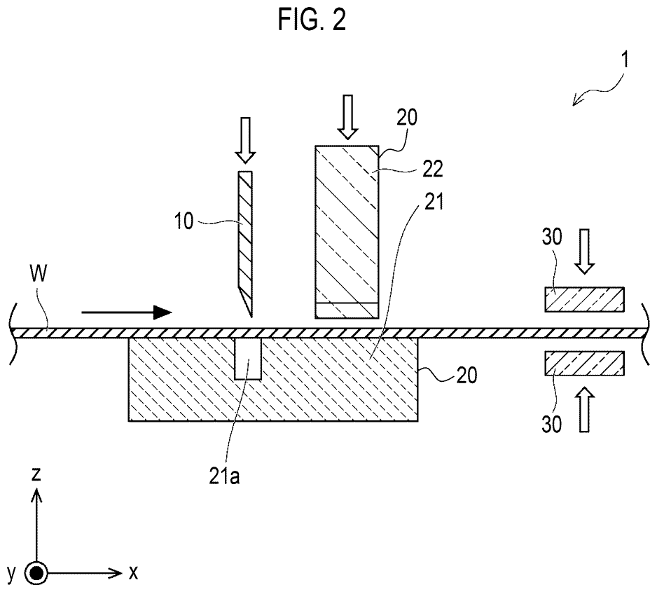

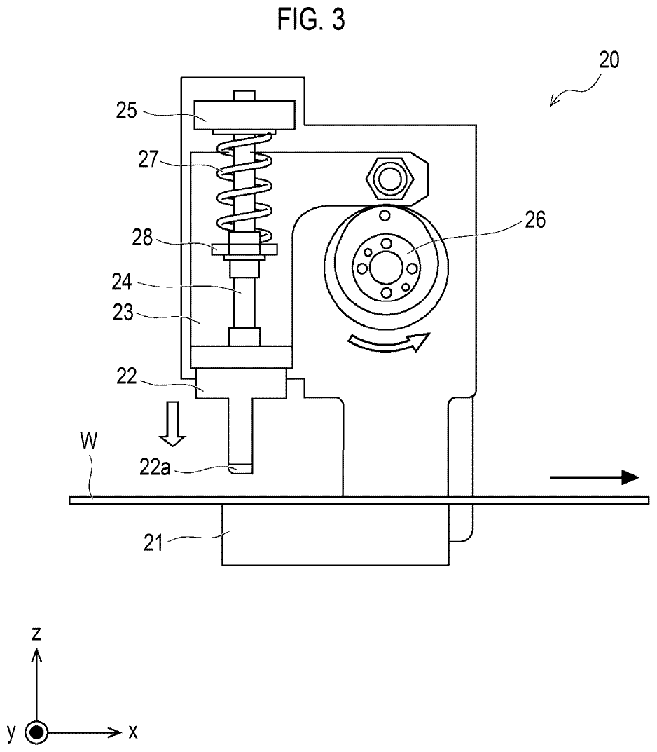

First, a processing apparatus 1 according to Embodiment 1 will be described with reference to FIGS. 1 to 3. FIG. 1 is a cross-sectional view showing an example of a processing apparatus according to the Embodiment 1. FIG. 2 is a cross-sectional view showing another example of the processing apparatus according to the Embodiment 1. FIG. 3 is a side view of a first chuck mechanism according to the Embodiment 1.

As shown in FIG. 1, the processing apparatus 1 includes a cutting mechanism 10, a first chuck mechanism 20, and a second chuck mechanism 30. The processing apparatus 1 cuts a workpiece transported along a first direction to a length that is predetermined. The processing apparatus 1 transports the cut workpiece to a subsequent process. The workpiece is not particularly limited, and examples thereof include a plate-shaped member and a linear member. Hereinafter, in the present embodiment, a coil wire W of the linear member extending along the first direction is used as a workpiece.

In the following description, the description will be made using an xyz three-dimensional orthogonal coordinate system as appropriate. In the present Embodiment 1, the first direction, which is the direction in which the coil wire W is transported, is set as an x-axis direction. In addition, in the following description, a z-axis direction is a vertical direction, and an xy plane is a horizontal plane. Of course, the z-axis direction may be a direction inclined from the vertical direction, and the xy plane may be a plane inclined from the horizontal plane.

The cutting mechanism 10 is a mechanism that cuts, by one or a plurality of cutting blades, the coil wire W transported along the x-axis direction (first direction) to a length that is predetermined. The cutting performed by the cutting mechanism 10 is not limited to cutting by the cutting blade, and may be, for example, melting and cutting by laser. The cutting mechanism 10 drives the cutting blade by, for example, an air cylinder or a motor (not shown).

The first chuck mechanism 20 fixes the coil wire W such that the coil wire W is held stationary while the cutting mechanism 10 is cutting the coil wire W. As shown in FIG. 1, a position where the first chuck mechanism 20 fixes the coil wire W is provided downstream (x-axis plus direction side) of a position where the cutting mechanism 10 cuts the coil wire W. As shown in FIG. 3, the first chuck mechanism 20 includes a fixed chuck 21, a movable chuck 22, a follower link 23, a linear-motion shaft 24, a guide 25, a cam 26, a spring 27, and a screw member 28.

The fixed chuck 21 is provided at a position facing the movable chuck 22 to be in contact with the coil wire W along the x-axis direction. That is, as shown in FIG. 1, the coil wire W is transported while being in contact with an upper surface (a surface on the positive z-axis direction side) of the fixed chuck 21.

As shown in FIG. 2, the fixed chuck 21 may have a shape extending along the x-axis direction from a position facing the movable chuck 22 to a position facing the cutting mechanism 10. In this case, the fixed chuck 21 has a groove 21a provided at a portion facing the cutting mechanism 10. The groove 21a suppresses the contact between the cutting blade of the cutting mechanism 10 and the fixed chuck 21 when the coil wire W is cut.

In a case where a linear member, such as the coil wire W, is a workpiece to be cut, an end portion of the coil wire W after being cut by the cutting mechanism 10 is likely to be vibrated due to an impact of the cutting. The coil wire W may be damaged by coming into contact with another member due to the vibration of the end portion. In a case of the fixed chuck 21 as shown in FIG. 2, an end portion of the coil wire W after being cut by the cutting mechanism 10 is held by the fixed chuck 21. Therefore, the vibration of the coil wire W due to the impact of cutting is suppressed by the fixed chuck 21.

The description returns to the description of FIG. 3. The movable chuck 22 is provided at a position where the movable chuck 22 clamps the coil wire W with the fixed chuck 21. The movable chuck 22 moves toward (negative z-axis direction) and away from (positive z-axis direction) the fixed chuck 21. The movable chuck 22 clamps the coil wire W with the fixed chuck 21 by moving toward the fixed chuck 21 (negative z-axis direction). The position of the coil wire W is fixed by being clamped by the fixed chuck 21 and the movable chuck 22. On the other hand, the fixed chuck 21 and the movable chuck 22 release the coil wire W by the movable chuck 22 moving away from the fixed chuck 21 (positive z-axis direction). That is, the coil wire W is released from the fixed state.

A material of a contact portion 22a provided at a distal end of the movable chuck 22 and brought into contact with the coil wire W may be a material different from the movable chuck 22, such as urethane resin or silicone resin, from the viewpoint of suppressing damage to the coil wire W. Further, from the viewpoint of suppressing damage to the coil wire W in the same manner, the contact portion 22a may have a taper on at least one side in the x-axis direction.

The follower link 23 is an inverted L-shaped member constituted by a long arm extending along the z-axis direction and a short arm extending along the x-axis direction. The long arm and the short arm may be reversed. A movable chuck 22 is provided on the end portion side of the follower link 23 (the negative z-axis direction side). In addition, the short arm of the follower link 23 is in contact with the cam 26 on an upper side (positive z-axis direction side) of the cam 26.

The linear-motion shaft 24 is a rod-shaped member extending in the z-axis direction, and is provided in the follower link 23. The linear-motion shaft 24 is restricted by the guide 25 to move solely along the z-axis direction. That is, the follower link 23 provided with the linear-motion shaft 24 is also restricted to move solely along the z-axis direction.

The cam 26 is provided to move the follower link 23 along the z-axis direction. The follower link 23 reciprocates along the linear-motion shaft 24, that is, along the z-axis direction by the rotation of the cam 26. As a result, the movable chuck 22 provided in the follower link 23 moves toward the fixed chuck 21 (negative z-axis direction) and away from the fixed chuck 21 (positive z-axis direction). As described above, since the movable chuck 22 is cam-driven to move, the first chuck mechanism 20 can shorten the operation time for clamping and releasing the coil wire W by the fixed chuck 21 and the movable chuck 22.

The spring 27 is provided on the linear-motion shaft 24. A first end (positive z-axis direction side) of the spring 27 is in contact with the guide 25, and a second end (negative z-axis direction side) of the spring 27 is in contact with a screw member 28 fixed to the linear-motion shaft 24. When the follower link 23 moves in the positive z-axis direction due to the rotation of the cam 26, the screw member 28 also moves in the positive z-axis direction. Then, the spring 27 is compressed and shrinks by the screw member 28 and the guide 25. When the cam 26 further rotates, the follower link 23 moves in the negative z-axis direction by an elastic force of the contracted spring 27 trying to return to the original shape. Therefore, the movable chuck 22 is pressed against the coil wire W by the elastic force of the spring 27. Therefore, the force with which the fixed chuck 21 and the movable chuck 22 clamp the coil wire W, that is, a clamping force of the coil wire W by the first chuck mechanism 20 is determined based on the elastic force of the spring 27.

Examples of methods for adjusting the elastic force of the spring 27 include a method of replacing the spring 27 with another spring having a different spring constant, and a method of changing the position of the screw member 28 relative to the linear-motion shaft 24 in the z-axis direction. Since the clamping force of the coil wire W by the first chuck mechanism 20 can be adjusted by these simple methods, the time for changing the set of the processing apparatus 1 can be shortened even when the coil wire W to be processed is changed to a coil wire W having a different thickness, material, or the like.

The description returns to the description of FIG. 1. The second chuck mechanism 30 grips the coil wire W cut by the cutting mechanism 10 and transports the coil wire W to a subsequent process. As shown in FIG. 1, a position where the second chuck mechanism 30 grips the coil wire W is provided downstream (in the x-axis plus direction) of a position where the first chuck mechanism 20 fixes the coil wire W. As a result, the position where the first chuck mechanism 20 fixes the coil wire W and the position where the cutting mechanism 10 cuts the coil wire W can be brought close to each other. Therefore, the vibration of the end portion of the coil wire W after cutting can be suppressed.

The second chuck mechanism 30 is constituted by a pair of chucks. Note that, a first side of the chucks may be a movable chuck and a second side of the chucks may be a fixed chuck, or both of the chucks may be movable chucks.

First, in the second chuck mechanism 30, the cut coil wire W is gripped by the chucks. Subsequently, the second chuck mechanism 30 transports the gripped coil wire W to a subsequent process. After the cut coil wire W is delivered to the subsequent process, the second chuck mechanism 30 returns to a gripping position of the coil wire W to be cut subsequently, that is, the vicinity of the first chuck mechanism 20. The second chuck mechanism 30 performs gripping and releasing operation of the coil wire W by an electric drive using a motor (not shown), for example. The gripping and releasing operation of the second chuck mechanism 30 is not limited to the electric drive, and may be a hydraulic drive, an air pressure drive, or the like. In addition, a moving direction of the second chuck mechanism 30 gripping the coil wire W, that is, a transport direction is not limited to the x-axis direction that is a direction in which the coil wire W is transported, and may be a y direction, the z-axis direction, or the like.

### Processing Method

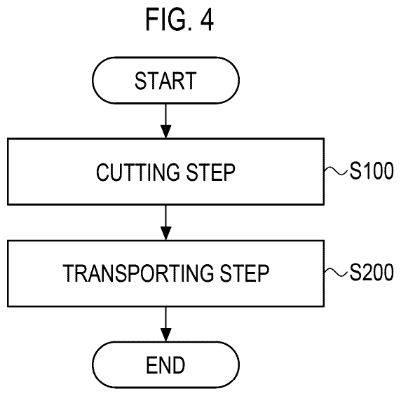

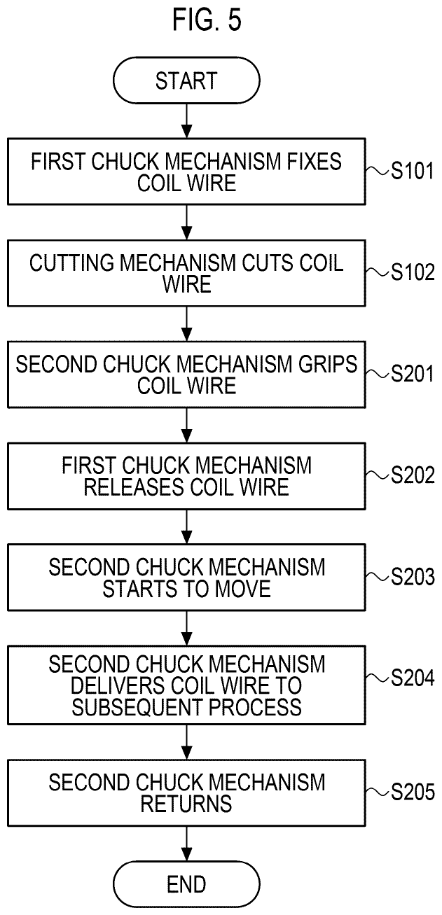

Next, a processing method of a coil wire W that is a workpiece using the processing apparatus 1 according to the Embodiment 1 will be described. FIG. 4 is a schematic view of a flowchart of one step in the processing method according to the Embodiment 1. FIG. 5 is a detailed view of the flowchart of one step in the processing method according to the Embodiment 1.

As shown in FIG. 4, the processing method according to the Embodiment 1 includes a cutting step (S100) of cutting the coil wire W fixed by the first chuck mechanism 20 and a transporting step (S200) of transporting the cut coil wire W to a subsequent process by the second chuck mechanism 30, and the steps are executed over a plurality of cycles. First, each of the cutting step (S100) and the transporting step (S200) for one cycle will be described with reference to FIG. 5.

Hereinafter, the cutting step (S100) will be described. First, the first chuck mechanism 20 fixes the coil wire W transported along the x-axis direction (first direction) (S101). Next, the cutting mechanism 10 cuts the coil wire W fixed by the first chuck mechanism 20 (S102). Accordingly, S101 and S102 are the cutting step (S100).

Next, the transporting step (S200) will be described. After the cutting mechanism 10 cuts the coil wire W, the second chuck mechanism 30 that is different from the first chuck mechanism 20 grips the cut coil wire W (S201). After the second chuck mechanism 30 grips the coil wire W or at the same time as the gripping, the first chuck mechanism 20 releases the coil wire W, that is, releases the fixing of the coil wire W (S202). Next, the second chuck mechanism 30 starts to move while gripping the coil wire W (S203). Then, the second chuck mechanism 30 delivers the coil wire W to the subsequent process (S204), and then returns to the gripping position of the coil wire W to be cut next, that is, the vicinity of the first chuck mechanism 20 (S205). The transporting steps of S201 to S205 are as described above (S200).

The processing method according to the present Embodiment 1 executes, as described above, a process of executing the transporting step (S200) after the cutting step (S100) over a plurality of cycles. Here, the processing method according to the present Embodiment 1 executes the cutting step (S100) in an (n+1)-th process during the execution of the transporting step (S200) in an n-th process, n being an integer of 1 or more. More specifically, after the second chuck mechanism 30 starts to move while gripping the coil wire W in the n-th process (S203), the (n+1)-th process is started. In this manner, the processing apparatus 1 can start the subsequent process without waiting for the return of the second chuck mechanism 30.

As described above, the processing apparatus 1 according to the present Embodiment 1 includes the first chuck mechanism 20 fixing the coil wire W to cut the coil wire W and the second chuck mechanism 30 transporting the cut coil wire W to the subsequent process such that the (n+1)-th process can be executed during the execution of the n-th process. Therefore, the processing apparatus 1 according to the present Embodiment 1 can reduce the cycle time for processing the coil wire W.

The present disclosure is not limited to the embodiment, and can be appropriately modified without departing from the spirit.

What is claimed is:

1. A processing apparatus comprising:
a cutting mechanism configured to cut a workpiece transported along a first direction;
a first chuck mechanism configured to fix the workpiece such that the workpiece is held stationary while the cutting mechanism is cutting the workpiece; and
a second chuck mechanism configured to grip and transport the cut workpiece to a subsequent process,
wherein a position where the first chuck mechanism fixes the workpiece is provided downstream in the first direction with respect to a position where the cutting mechanism cuts the workpiece, and
wherein a position where the second chuck mechanism grips the cut workpiece is provided downstream in the first direction with respect to the position where the first chuck mechanism fixes the workpiece.

2. The processing apparatus according to claim 1, wherein:
the first chuck mechanism includes a fixed chuck provided at a position that is in contact with the workpiece along the first direction, and a movable chuck provided at a position where the movable chuck clamps the workpiece with the fixed chuck; and
the movable chuck is cam-driven to move toward and away from the fixed chuck.

3. The processing apparatus according to claim 2, wherein a clamping force of the workpiece by the first chuck mechanism is based on an elastic force of a spring provided in the movable chuck.

4. The processing apparatus according to claim 2, wherein:
the workpiece is a linear member extending along the first direction; and
the cutting mechanism is provided at a position where the workpiece is clamped between the fixed chuck and the cutting mechanism, and cuts the workpiece on the fixed chuck.

5. A processing method comprising:
a cutting step of cutting a workpiece fixed by a chuck; and
a transporting step of transporting the cut workpiece to a subsequent process by a chuck different from the chuck,
wherein a process of executing the transporting step after the cutting step is executed over a plurality of cycles, and
wherein the cutting step in an (n+1)-th process is executed during the execution of the transporting step in an n-th process, n being an integer of 1 or more.
